(19) United States
(12) Patent Application Publication
(10) Pub. No.: US 2026/0025690 A1
(43) Pub. Date: Jan. 22, 2026

(54) UE Selection for Minimization of Drive Test (MDT)

(71) Applicant: Telefonaktiebolaget LM Ericsson (publ), Stockholm (SE)

(72) Inventors: Kiyul Kwon, Seoul (KR); Jaewook Lee, Seoul (KR); Angelo Centonza, Torrenueva Costa (ES); Changwoo Hong, Seoul (KR); Hwajoon Cha, Seoul (KR)

(21) Appl. No.: 18/997,340

(22) PCT Filed: Jun. 29, 2023
(86) PCT No.: PCT/EP2023/067829

§ 371 Date: Jan. 21, 2025

(30) Foreign Application Priority Data
Jul. 25, 2022 (WO) PCT/EP2022/070812

(51) Int. Cl. H04W 24/10; H04W 84/04

(52) U.S. Cl. CPC H04W 24/10; H04W 84/042

(57) ABSTRACT

The present disclosure is related to a RAN node, a management system, a CN node, and methods for UE selection for MDT. A method at a RAN node for selecting one or more UEs for MDT comprises: receiving UE selection information indicating one or more criteria for selecting UEs for MDT; and selecting the one or more UEs for MDT based on at least the received UE selection information.

### TECHNICAL FIELD

The present disclosure is related to the field of telecommunication, and in particular, to a Radio Access Network (RAN) node, a management system, a Core Network (CN) node, and methods for UE selection for minimization of drive test (MDT).

### BACKGROUND

With the development of the electronic and telecommunications technologies, mobile devices, such as mobile phones, smart phones, laptops, tablets, vehicle mounted devices, become an important part of our daily lives. To support a numerous number of mobile devices, a highly efficient and optimized telecommunication system, such as a fifth generation system (5GS), will be required.

To optimize the telecommunication system, network test equipments are required. However, there is a critical need to refresh and update network test equipment so that the performance of the 5GS can be successfully and accurately measured. The major restraint of the network test market is that it is very labor-intensive. Operators and network equipment manufacturers are under pressure to reduce the manpower that they deploy in this area, which reduces the amount of test equipment purchased. Network operators need to know where the network coverage is supposed to go, as customer churn is expensive and poor coverage and poor service are the top drivers of churn. Service Providers require effective network testing products and solutions that protect their existing investment.

MDT is expected to be a key competitor for network testing, as it provides the option of collecting data without even sending a person to the location of the network. With MDT, instead of dispatching test trucks and engineers, any User Equipment (UE) around the interested area may be used for performing all those measurements and storing the results in the device and then reporting it later. Therefore, MDT is truly wireless in this sense and will also reduce the cost of drive testing for network optimization.

### SUMMARY

According to a first aspect of the present disclosure, a method at a RAN node for selecting one or more UEs for MDT is provided. The method comprises: receiving UE selection information indicating one or more criteria for selecting UEs for MDT; and selecting the one or more UEs for MDT based on at least the received UE selection information.

In some embodiments, the method further comprises: receiving user consent information associated with the one or more UEs, wherein the step of selecting the one or more UEs for MDT is further based on at least the received user consent information. In some embodiments, the user consent information associated with each of the UEs comprises a list of Public Land Mobile Networks (PLMNs) where MDT is allowed for the corresponding UE. In some embodiments, the one or more criteria indicate at least one of: one or more Masked International Mobile Equipment Identifier and Software Versions (IMEISVs); one or more UE capabilities; one or more types of service; one or more mobility states; one or more frequencies; one or more frequency bands; and one or more network slices.

In some embodiments, when the criteria indicate the list of PLMNs, each of the one or more UEs selected for MDT is connected to at least one of the PLMNs in the list. In some embodiments, the one or more masked IMEISVs comprise at least one masked IMEISV defined in Third Generation Partnership Project (3GPP) Technical Specification (TS) 38.413, V17.1.1 and/or any of its preceding releases. In some embodiments, when the criteria indicate the one or more masked IMEISVs, each of the one or more UEs selected for MDT has an IMEISV matched with at least one of the one or more masked IMEISVs. In some embodiments, the one or more UE capabilities comprise at least one UE capability defined in 3GPP TS 38.306, V17.0.0 and/or any of its preceding releases. In some embodiments, when the criteria indicate the one or more UE capabilities, each of the one or more UEs selected for MDT supports all of the one or more UE capabilities. In some embodiments, the one or more types of service are classified by at least one of: one or more service identifiers; one or more 5G Quality of Service (QoS) Identifiers (5QIs) associated to one or more QoS flows; one or more QoS Class Identifiers (QCIs) associated to one or more Data Radio Bearers (DRBs); whether a service is a Guaranteed Bit Rate (GBR) service or a non-GBR service; and one or more establishment causes. In some embodiments, when the criteria indicate the one or more types of service, each of the one or more UEs selected for MDT supports at least one of the one or more types of services.

In some embodiments, the one or more mobility states comprise at least one mobility state defined in 3GPP TS 38.304, V17.0.0 and/or any of its preceding releases. In some embodiments, when the criteria indicate the one or more mobility states, each of the one or more UEs selected for MDT has one of the one or more mobility states. In some embodiments, the one or more frequencies and/or one or more frequency bands are indicated by at least one of: one or more licensed frequencies; one or more unlicensed frequencies; Frequency Range 1 (FR1) and/or Frequency Range 2 (FR2); one or more Absolute Radio Frequency Channel Number (ARFCN) values; and one or more frequency band indexes. In some embodiments, when the criteria indicate the one or more frequencies and/or frequency bands, each of the one or more UEs selected for MDT is using at least one of the one or more frequencies and/or at least one of the one or more frequency bands. In some embodiments, when the criteria indicate the one or more network slices, each of the one or more UEs selected for MDT is using at least one of the one or more network slices.

In some embodiments, when the UE selection information indicates multiple criteria for selecting UEs, the selected UEs satisfy all of the multiple criteria. In some embodiments, the UE selection information is received from a management system and/or a CN node. In some embodiments, the UE selection information is received in at least one of: an MDT configuration from a management system; an interface management related message from a CN node; a UE related message from a CN node. In some embodiments, the interface management related message comprises at least one of: an NG SETUP REQUEST message; an RAN CONFIGURATION UPDATE message; and an AMF CONFIGURATION UPDATE message. In some embodiments, the UE related message comprises at least one of: an INITIAL CONTEXT SETUP REQUEST message; and a HANDOVER REQUEST message.

In some embodiments, the method further comprises: receiving one or more indicators together with or separately from the UE selection information, each of which indicating a minimum number of UEs that should be selected for MDT under a corresponding condition. In some embodiments, the one or more indicators indicate at least one of: a minimum number of UEs that should be selected per MDT measurement configuration; a minimum number of UEs that should be selected per cell; a minimum number of UEs that should be selected per Tracking Area (TA); a minimum number of UEs that should be selected per PLMN; and a minimum number of UEs that should be selected per RAN node.

In some embodiments, the method further comprises, in response to an indicated minimum number of UEs that should be selected for MDT under a condition being greater than a number of UEs available for selection under the condition, at least one of: failing a MDT measurement process and not reporting any indication; failing a MDT measurement process and reporting a failure cause indicating that there is no sufficient number of UEs available for selection; and collecting and reporting measurements from the selected UEs with an indication indicating at least one of: the number of the selected UEs being less than the indicated minimum number; the number of the selected UEs; and a reason why the indicated minimum number of UEs are not selected.

In some embodiments, when the UE selection information indicates multiple criteria for selecting UEs, each of the multiple criteria has an associated priority level. In some embodiments, when there is no sufficient number of UEs that satisfy all of the multiple criteria and are available for selection for a specified period of time, the multiple criteria are discarded one by one in an ascending order of their priority levels after every specified period of time until a sufficient number of UEs that satisfy the remaining criteria are available for selection. In some embodiments, the method further comprises: reporting the criteria that are discarded. In some embodiments, the MDT is a Management Based MDT. In some embodiments, the MDT is an immediate MDT and/or a logged MDT.

According to a second aspect of the present disclosure, a RAN node is provided. The RAN node comprises: a processor; a memory storing instructions which, when executed by the processor, cause the processor to perform any of the methods of the first aspect.

According to a third aspect of the present disclosure, a RAN node for selecting one or more UEs for MDT is provided. The RAN node comprises: a receiving module configured to receive UE selection information indicating one or more criteria for selecting UEs for MDT; and a selecting module configured to select the one or more UEs for MDT based on at least the received UE selection information. In some embodiments, the RAN node may comprise one or more further modules configured to perform one or more steps of any of the methods of the first aspect.

According to a fourth aspect of the present disclosure, a method at a management system for facilitating a RAN node in selecting one or more UEs for MDT is provided. The method comprises: transmitting, to the RAN node, UE selection information indicating one or more criteria for selecting UEs for MDT.

In some embodiments, the criteria indicate at least one of: one or more Masked IMEISVs; one or more UE capabilities; one or more types of service; one or more mobility states; one or more frequencies; one or more frequency bands; and one or more network slices. In some embodiments, the one or more masked IMEISVs comprise at least one masked IMEISV defined in 3GPP TS 38.413, V17.1.1 and/or any of its preceding releases. In some embodiments, the one or more UE capabilities comprise at least one UE capability defined in 3GPP TS 38.306, V17.0.0 and/or any of its preceding releases. In some embodiments, the one or more types of service are classified by at least one of: one or more service identifiers; one or more 5QIs associated to one or more QoS flows; one or more QCIs associated to one or more DRBs; whether a service is a GBR service or a non-GBR service; and one or more establishment causes. In some embodiments, the one or more mobility states comprise at least one mobility state defined in 3GPP TS 38.304, V17.0.0 and/or any of its preceding releases. In some embodiments, the one or more frequencies and/or one or more frequency bands are indicated by at least one of: one or more licensed frequencies; one or more unlicensed frequencies; FR1 and/or FR2; one or more ARFCN values; and one or more frequency band indexes.

In some embodiments, the UE selection information is transmitted in an MDT configuration from the management system to the RAN node. In some embodiments, the method further comprises: transmitting, to the RAN node, one or more indicators together with or separately from the UE selection information, each of which indicating a minimum number of UEs that should be selected for MDT under a corresponding condition. In some embodiments, the one or more indicators indicate at least one of: a minimum number of UEs that should be selected per MDT measurement configuration; a minimum number of UEs that should be selected per cell; a minimum number of UEs that should be selected per TA; a minimum number of UEs that should be selected per PLMN; and a minimum number of UEs that should be selected per RAN node.

In some embodiments, the method further comprises at least one of: receiving, from the RAN node, a failure cause indicating that there is no sufficient number of UEs available for selection; and receiving, from the RAN node, measurements from the selected UEs with an indication indicating at least one of: the number of the selected UEs being less than the indicated minimum number; the number of the selected UEs; and a reason why the indicated minimum number of UEs are not selected.

In some embodiments, when the UE selection information indicates multiple criteria for selecting UEs, each of the multiple criteria has an associated priority level. In some embodiments, the method further comprises: receiving, from the RAN node, a message indicating the criteria that are discarded by the RAN node. In some embodiments, the MDT is a Management Based MDT. In some embodiments, the MDT is an immediate MDT and/or a logged MDT.

According to a fifth aspect of the present disclosure, a management system is provided. The management system comprises: a processor; a memory storing instructions which, when executed by the processor, cause the processor to perform any of the methods of the fourth aspect.

According to a sixth aspect of the present disclosure, a management system for facilitating a RAN node in selecting one or more UEs for MDT is provided. The management system comprises: a transmitting module configured to transmit, to the RAN node, UE selection information indicating one or more criteria for selecting UEs for MDT. In some embodiments, the management system may comprise one or more further modules configured to perform one or more steps of any of the methods of the fourth aspect.

According to a seventh aspect of the present disclosure, a method at a CN node for facilitating a RAN node in selecting one or more UEs for MDT is provided. The method comprises: transmitting, to the RAN node, UE selection information indicating one or more criteria for selecting UEs for MDT.

In some embodiments, the method further comprises: transmitting, to the RAN node, user consent information associated to one or more UEs. In some embodiments, the user consent information associated with each of the UEs comprises a list of PLMNs where MDT is allowed for the corresponding UE. In some embodiments, the criteria indicate at least one of: one or more Masked IMEISVs; one or more UE capabilities; one or more types of service; one or more mobility states; one or more frequencies; one or more frequency bands; and one or more network slices. In some embodiments, the one or more masked IMEISVs comprise at least one masked IMEISV defined in 3GPP TS 38.413, V17.1.1 and/or any of its preceding releases. In some embodiments, the one or more UE capabilities comprise at least one UE capability defined in 3GPP TS 38.306, V17.0.0 and/or any of its preceding releases. In some embodiments, the one or more types of service are classified by at least one of: one or more service identifiers; one or more 5QIs associated to one or more QoS flows; one or more QCIs associated to one or more DRBs; whether a service is a GBR service or a non-GBR service; and one or more establishment causes. In some embodiments, the one or more mobility states comprise at least one mobility state defined in 3GPP TS 38.304, V17.0.0 and/or any of its preceding releases. In some embodiments, the one or more frequencies and/or one or more frequency bands are indicated by at least one of: one or more licensed frequencies; one or more unlicensed frequencies; FR1 and/or FR2; one or more ARFCN values; and one or more frequency band indexes.

In some embodiments, the UE selection information is transmitted in at least one of: an interface management related message; a UE related message. In some embodiments, the interface management related message comprises at least one of: an NG SETUP REQUEST message; an RAN CONFIGURATION UPDATE message; and an AMF CONFIGURATION UPDATE message. In some embodiments, the UE related message comprises at least one of: an INITIAL CONTEXT SETUP REQUEST message; and a HANDOVER REQUEST message.

In some embodiments, the method further comprises: transmitting, to the RAN node, one or more indicators together with or separately from the UE selection information, each of which indicating a minimum number of UEs that should be selected for MDT under a corresponding condition. In some embodiments, the one or more indicators indicate at least one of: a minimum number of UEs that should be selected per MDT measurement configuration; a minimum number of UEs that should be selected per cell; a minimum number of UEs that should be selected per TA; a minimum number of UEs that should be selected per PLMN; and a minimum number of UEs that should be selected per RAN node. In some embodiments, when the UE selection information indicates multiple criteria for selecting UEs, each of the multiple criteria has an associated priority level. In some embodiments, the MDT is a Management Based MDT. In some embodiments, the MDT is an immediate MDT and/or a logged MDT.

According to an eighth aspect of the present disclosure, a CN node is provided. The CN node comprises: a processor; a memory storing instructions which, when executed by the processor, cause the processor to perform any of the methods of the seventh aspect.

According to a ninth aspect of the present disclosure, a CN node for facilitating a RAN node in selecting one or more UEs for MDT is provided. The CN node comprises: a transmitting module configured to transmit, to the RAN node, UE selection information indicating one or more criteria for selecting UEs for MDT. In some embodiments, the CN node may comprise one or more further modules configured to perform one or more steps of any of the methods of the seventh aspect.

According to a tenth aspect of the present disclosure, a computer program comprising instructions is provided. The instructions, when executed by at least one processor, cause the at least one processor to carry out any of the methods of any of the first, fourth, and seventh aspects.

According to an eleventh aspect of the present disclosure, a carrier containing the computer program of the tenth aspect is provided. In some embodiments, the carrier is one of an electronic signal, optical signal, radio signal, or computer readable storage medium.

According to a twelfth aspect of the present disclosure, a telecommunication system for selecting one or more UEs for MDT is provided. The telecommunication system comprises: a RAN node of the second or third aspect; a management system of the fifth or sixth aspect; and a CN node of the eighth or nineth aspect.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and therefore are not to be considered limiting of its scope, the disclosure will be described with additional specificity and detail through use of the accompanying drawings.

FIG. 1 is a block diagram illustrating an exemplary telecommunication network in which UE selection for MDT may be applicable according to an embodiment of the present disclosure.

FIG. 2 is a diagram illustrating an exemplary MDT procedure in which UE selection for MDT may be applicable according to an embodiment of the present disclosure.

FIG. 3 is a diagram illustrating an exemplary masked IMEISV that can be used for UE selection for MDT according to an embodiment of the present disclosure.

FIG. 4 through FIG. 9 are diagrams illustrating exemplary MDT procedures in which UE selection for MDT is applied according to some embodiments of the present disclosure.

FIG. 10 is a flow chart illustrating an exemplary method for selecting one or more UEs for MDT according to an embodiment of the present disclosure.

FIG. 11 is a flow chart illustrating another exemplary method for selecting one or more UEs for MDT according to another embodiment of the present disclosure.

FIG. 12 is a flow chart illustrating an exemplary method at a RAN node for selecting one or more UEs for MDT according to an embodiment of the present disclosure.

FIG. 13 is a flow chart illustrating an exemplary method at a management system for facilitating a RAN node in selecting one or more UEs for MDT according to an embodiment of the present disclosure.

FIG. 14 is a flow chart illustrating an exemplary method at a CN node for facilitating a RAN node in selecting one or more UEs for MDT according to an embodiment of the present disclosure.

FIG. 15 schematically shows an embodiment of an arrangement which may be used in a RAN node, a management system, and/or a CN node according to an embodiment of the present disclosure.

FIG. 16 is a block diagram of an exemplary RAN node according to an embodiment of the present disclosure.

FIG. 17 is a block diagram of an exemplary management system according to an embodiment of the present disclosure.

FIG. 18 is a block diagram of an exemplary CN node according to an embodiment of the present disclosure.

### DETAILED DESCRIPTION

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first” and “second,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. In addition, language such as the phrase “at least one of X, Y and Z,” unless specifically stated otherwise, is to be understood with the context as used in general to convey that an item, term, etc. may be either X, Y, or Z, or a combination thereof.

The terminology used herein is for the purpose of describing particular embodiments only and is not intended to be limitation of example embodiments. As used herein, the singular forms “a”, “an”, and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It will be also understood that the terms “connect(s),” “connecting”, “connected”, etc. when used herein, just mean that there is an electrical or communicative connection between two elements and they can be connected either directly or indirectly, unless explicitly stated to the contrary.

Of course, the present disclosure may be carried out in other specific ways than those set forth herein without departing from the scope and essential characteristics of the disclosure. One or more of the specific processes discussed below may be carried out in any electronic device comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the disclosure is not limited to the disclosed embodiments, but instead is also capable of numerous rearrangements, modifications, and substitutions without departing from the present disclosure that as will be set forth and defined within the claims.

Further, although the following description of some embodiments of the present disclosure is given in the context of 5G system (5GS), the present disclosure is not limited thereto. In fact, as long as UE selection for MDT is involved, the inventive concept of the present disclosure may be applicable to any appropriate communication architecture, for example, to Global System for Mobile Communications (GSM)/General Packet Radio Service (GPRS), Enhanced Data Rates for GSM Evolution (EDGE), Code Division Multiple Access (CDMA), Wideband CDMA (WCDMA), Time Division-Synchronous CDMA (TD-SCDMA), CDMA2000, Worldwide Interoperability for Microwave Access (WiMAX), Wireless Fidelity (Wi-Fi), Long Term Evolution (LTE), Evolved Packet System (EPS), 5G New Radio (NR), etc. Therefore, one skilled in the arts could readily understand that the terms used herein may also refer to their equivalents in any other infrastructure. For example, the term “User Equipment” or “UE” used herein may refer to a mobile device, a mobile terminal, a mobile station, a user device, a user terminal, a wireless device, a wireless terminal, an Internet of Things (IoT) device, a vehicle, or any other equivalents. For another example, the term “network node” used herein may refer to a base station, a base transceiver station, an access point, a hot spot, a NodeB (NB), an evolved NodeB (eNB), a gNB, a network element, a network function, or any other equivalents.

Further, following 3GPP documents are incorporated herein by reference in their entireties:
3GPP TS 32.422 V17.7.1 (2022-06), Technical Specification, 3rd Generation Partnership Project; Technical Specification Group Services and System Aspects; Telecommunication management; Subscriber and equipment trace; Trace control and configuration management (Release 17);
3GPP TS 37.320 V17.1.0 (2022-06), Technical Specification, 3rd Generation Partnership Project; Technical Specification Group Radio Access Network; Radio measurement collection for Minimization of Drive Tests (MDT); Overall description; Stage 2 (Release 17);
3GPP TS 38.331 V17.1.0 (2022-06), Technical Specification, 3rd Generation Partnership Project; Technical Specification Group Radio Access Network; NR; Radio Resource Control (RRC) protocol specification (Release 17); and
3GPP TS 38.413 V17.1.1 (2022-06), Technical Specification, 3rd Generation Partnership Project; Technical Specification Group Radio Access Network; NG-RAN; NG Application Protocol (NGAP) (Release 17).

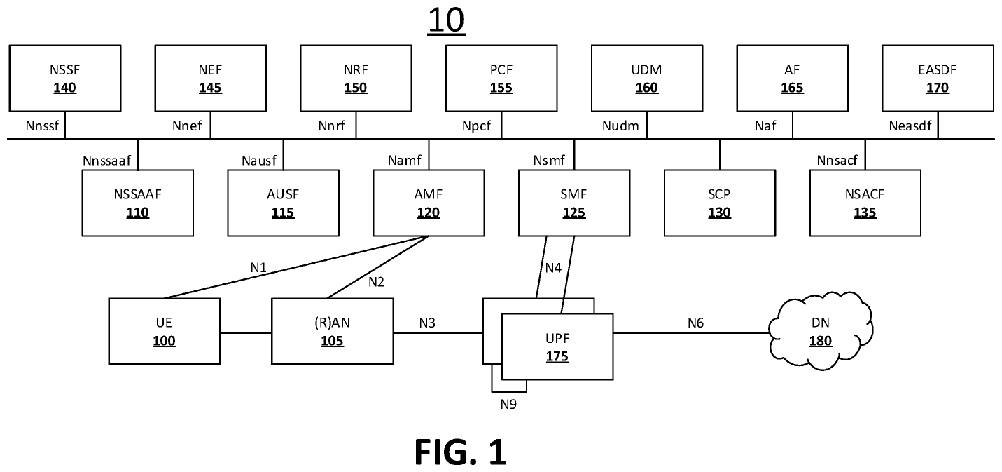

FIG. 1 is a block diagram illustrating an exemplary telecommunication network 10 in which UE selection for MDT may be applicable according to an embodiment of the present disclosure. Although the telecommunication network 10 is a network defined in the context of 5GS, the present disclosure is not limited thereto.

As shown in FIG. 1, the network 10 may comprise one or more UEs 100 and a (radio) access network ((R)AN) 105 comprising one or more RAN nodes, such as a base station, a Node B, an evolved NodeB (eNB), a gNB, or an Access Network (AN) node which provides the UEs 100 with access to other parts of the network 10. Further, the network 10 may comprise its core network portion comprising (but not limited to) a Network Slice-specific and SNPN (Stand-alone Non-Public Network) Authentication and Authorization Function (NSSAAF) 110, an Authentication Server Function (AUSF) 115, an Access and Mobility Management Function (AMF) 120, a Session Management Function (SMF) 125, a Service Communication Proxy (SCP) 130, a Network Slice Admission Control Function (NSACF) 135, a Network Slice Selection Function (NSSF) 140, a Network Exposure Function (NEF) 145, a Network Repository Function (NRF) 150, a Policy Control Function (PCF) 155, a Unified Data Management (UDM) 160, an Application Function (AF) 165, an Edge Application Server Discovery Function (EASDF) 170, and one or more User Plane Functions (UPFs) 175. As shown in FIG. 1, these entities may communicate with each other via the service-based interfaces, such as, Namf, Nsmf, etc. and/or the reference points, such as, N1, N2, N3, N4, N6, N9, etc.

However, the present disclosure is not limited thereto. In some other embodiments, the network 10 may comprise additional network functions, less network functions, or some variants of the existing network functions shown in FIG. 1. For example, in a network with the 4G EPS architecture, the entities which perform these functions (e.g., Mobility Management Entity (MME)) may be different from those shown in FIG. 1 (e.g., the AMF 120). For another example, in a network with a mixed 4G/5G architecture, some of the entities may be same as those shown in FIG. 1, and others may be different. Further, the functions shown in FIG. 1 are not essential to the embodiments of the present disclosure. In other words, some of them may be missing from some embodiments of the present disclosure.

As shown in FIG. 1, the UPFs 175 are communicatively connected to a Data Network (DN) 180 which may be, or in turn communicatively connected to, the Internet, such that the UE 100 may finally communicate its user plane data with other devices outside the network 10, for example, via the RAN 105 and the UPFs 175.

Some of the network functions shown in FIG. 1 that may be involved in some embodiments of the present disclosure will be described below.

In some embodiments, the AMF 120 may support (but not limited to) at least one of:
Termination of RAN Control Plane (CP) interface (N2).
Termination of Non Access Stratum (NAS) (N1), NAS ciphering and integrity protection.
Registration management.
Connection management.
Reachability management.
Mobility Management.
Subscriber information management related to MDT, e.g., user consent information.

MDT is a feature specified for networks (e.g., 3G, 4G and/or 5G networks). In some embodiments of the present disclosure, 5G networks are taken as examples, and therefore the present disclosure is not limited thereto.

As mentioned earlier, MDT functionality involves measurements performed by UEs (e.g., the UEs 100) and reporting of the measurements to RAN (e.g., the RAN 105). The MDT provides a remote method used for troubleshooting or verification of the radio network, which is simpler and cheaper than traditional drive tests. It provides a tool to optimize network planning with the MDT measurement data including location information.

In some embodiments, there are two cases that a RAN should initiate an MDT measurements collection task. One is that the MDT task is initiated without targeting a specific UE by the cell traffic trace, i.e. management based trace function from Operation, Administration, and Maintenance (OAM). The other is that the MDT task is initiated towards a specific UE by the signaling trace activation messages from CN nodes, e.g. the Initial Context Setup message, the Trace Start message or the Handover Request message in Evolved Universal Terrestrial RAN (E-UTRAN) or NR, the CN Invoke Trace message in UTRAN. The detailed procedures to transfer the MDT configurations to RAN are specified in TS 32.422.

For signalling based MDT, the CN shall not initiate MDT towards a particular user unless it is allowed.

For management based MDT, the CN indicates to the RAN whether MDT is allowed to be configured by the RAN for this user considering e.g. user consent and roaming status (see TS 32.422), by providing management based MDT allowed information. For E-UTRAN/UTRAN, the MDT allowed information consists of the Management Based MDT Allowed indication and optionally the Management Based MDT PLMN List. For NR, the MDT allowed information only consists of the Management Based MDT PLMN List. The management based MDT allowed information propagates during inter-PLMN handover if the Management Based MDT PLMN List is available and includes the target PLMN.

In some embodiments, a UE is configured with an MDT PLMN List only if user consent is valid for the Registered PLMN (RPLMN).

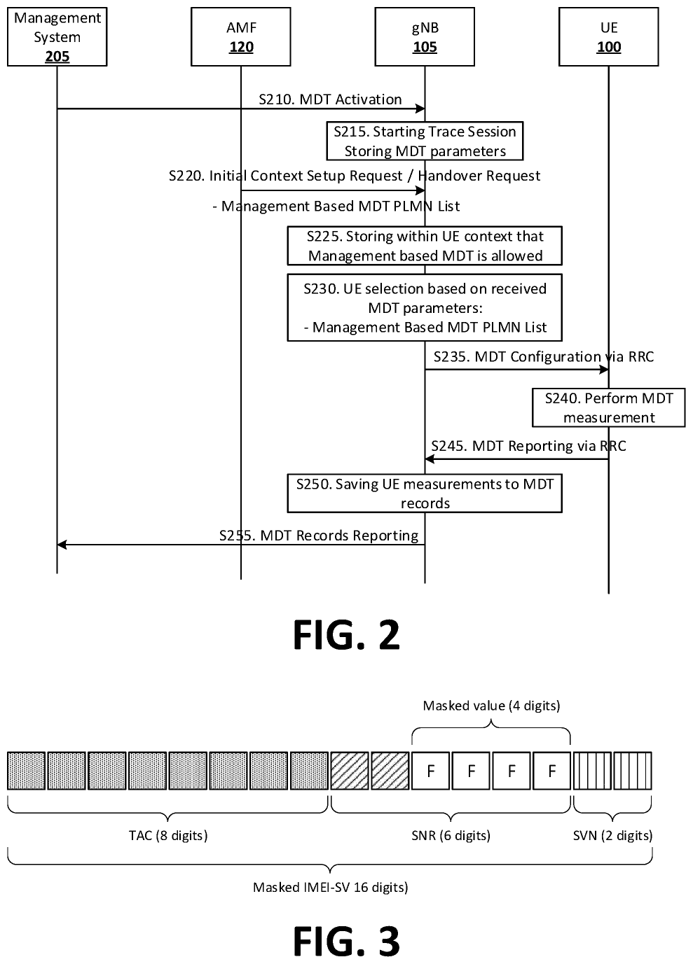

FIG. 2 is a diagram illustrating an exemplary Management Based MDT procedure in which UE selection for MDT may be applicable according to an embodiment of the present disclosure. Although FIG. 2 is taking a 5G system as an example, the same process may occur in 3G, 4G, or any other telecommunication system.

The procedure may begin at step S210 where a management system 205 may send a Trace Session activation request to a RAN node (e.g., the gNB 105 shown in FIG. 1). This request may include (but not limited to) one or more of the following parameters for configuring UE measurements:
Job Type.
Area Scope where the UE measurements should be collected: list of NG-RAN cells. Tracking Area should be converted to NG-RAN cell.
List of Measurements.
Reporting Trigger.
Report Interval.
Report Amount.
Event Threshold.
Logging Interval.
Logging Duration.
Trace Reference.
Trace Collection Entity (TCE) IP Address.
Anonymization of MDT Data.
Collection Period for Radio Resource Management (RRM) Measurements NR (present only if any of M4 or M5 measurements are requested).
Collection Period M6 in NR (present only if any of M6 measurements (Downlink (DL) or Uplink (UL)) is requested).
Collection Period M7 in NR (present only if any of M7 measurements (DL or UL) is requested).
Positioning Method.
MDT PLMN List.
Report Type for Logged MDT (periodical logged or event-triggered measurement) for logged MDT only.
Event Threshold, Hysteresis and Time to Trigger (present only if L1 event is configured for logged MDT)
Event List for Event Triggered Measurement for logged MDT only.
Area Configuration for Neighboring Cells for logged MDT only.
Sensor Information for logged MDT and immediate MDT.

In some embodiments, at the same time not all the parameters can be present.

At step S215, when the gNB 105 receives the Trace Session activation request from its management system 205, it may start a Trace Session and may save the received parameters associated to the Trace Session.

When the gNB 105 receives the Management based MDT allowed IE in Initial Context Setup Request or in Handover Request message at step S220, the gNB 105 may save it at step S225 for possible later usage.

At step S230, the gNB 105 may select the suitable UEs for MDT data collection. The selection may be based on the area received from the management system 205 and the area where UE is located, user consent information received from the core network (e.g., the AMF 120) as part of the Management based MDT PLMN List IE. If the user is not in the specified area or if the Management based MDT PLMN List IE is not present in the UE context, the UE shall not be selected by the gNB 105 for MDT data collection.

At step S235, the gNB 105 may activate the MDT functionality to the selected UEs 100. When the gNB 105 selects a UE 100, it may take into account the availability of Management based MDT PLMN List IE in the user context and the area scope parameter received in MDT configuration (Trace Session activation). If there is no Management based MDT PLMN List IE in the user context or the user is outside the area scope defined in the MDT configuration, the UE shall not be selected for MDT data collection. The gNB 105 may assign Trace Recording Session Reference corresponding to the selected UE 100. The gNB 105 may send at least one of the following configuration information to the UE 100 in case of Logged MDT:
Trace Reference,
Trace Recording Session Reference;
TCE Id (The value signaled as IP address of TCE from the Element Manager (EM) is mapped to a TCE Id, using a configured mapping in the gNB 105);
Logging Interval;
Logging Duration;
Absolute time reference;
Area Scope where the UE measurements should be collected: list of NG-RAN cells/TA;
MDT PLMN List.

In some embodiments, for UEs 100 currently being in idle or inactive mode and camping in the cell the logged MDT configuration cannot be sent, these UEs 100 may be configured when they initiate some activity (e.g., Service Request or Tracking Area Update) at next time.

In case of Immediate MDT, at least one of the following parameters may be sent to the UE 100:
List of Measurements;
Reporting Trigger;
Report Interval;
Report Amount;
Event Threshold.

In some embodiments, at the same time not all the parameters can be present.

At step S240, when UE 100 receives the MDT activation, it may start the MDT functionality based on the received configuration parameters.

The gNB 105 may receive an MDT report from the UE 100 at step S245 and save it to MDT records at step S250. At step S255, the gNB 105 may report, to the management system 205, the saved MDT records.

As described above, upon receipt of the INITIAL CONTEXT SETUP REQUEST message (e.g., step S220), the NG-RAN node (or the gNB 105) may store the received Management Based MDT PLMN List information, if supported, in the UE context. Such information may consist of a list of PLMNs where MDT is allowed for a user. It is a subset of the Equivalent PLMN (EPLMN) list and RPLMN at the time when MDT is initiated. If the Management Based MDT PLMN List IE is contained in the HANDOVER REQUEST message, the target NG-RAN node (or the gNB 105) may, if supported, store the received information in the UE context, and use this information to allow subsequent selections of the UE for management based MDT.

As also described above, in the RAN side, there are two modes of operation for MDT, which are immediate MDT and logged MDT. Immediate MDT is MDT functionality involving measurements performed by the UE 100 in CONNECTED state and reporting of the measurements to RAN available at the time of reporting condition as well as measurements by the network for MDT purposes. Meanwhile, logged MDT is MDT functionality involving measurement logging by UE 100 in IDLE mode, INACTIVE state, CELL_PCH, URA_PCH states and/or CELL_FACH state when second Discontinuous Reception (DRX) cycle is used (when UE 100 is in UTRA) for reporting to eNB/RNC/gNB at a later point in time, and logging of Multicast-broadcast Single-frequency Network (MBSFN) measurements by E-UTRA UE in IDLE and CONNECTED modes.

One of the reported information as part of MDT is downlink pilot signal strength. The measurement quantities for downlink pilot strength measurement logging are fixed and consist of both Reference Signal Received Power (RSRP) and Reference Signal Received Quality (RSRQ) for EUTRA, both Received Signal Code Power (RSCP) and Ec/No for UTRA FDD, P-CCPCH RSCP for UTRA 1.28 Mcps TDD, Rxlev for GERAN, and Pilot Pn Phase and Pilot Strength for CDMA2000 if the serving cell is EUTRAN cell, and both RSRP and RSRQ for NR.

FIG. 3 is a diagram illustrating an exemplary masked IMEISV that can be used for UE selection for MDT according to an embodiment of the present disclosure. The IMEISV is a unique number of a mobile equipment and it may include information on the origin, model, serial number, and software version of the mobile equipment. 3GPP defines the Masked IMEISV which contains the IMEISV value with a mask, to identify a terminal model and SW version without identifying an individual Mobile Equipment. As shown in FIG. 3, an IMEISV may comprise a Type Allocation code (TAC) field of 8 digits, a Serial Number (SNR) field of 6 digits, and a Software Version (SVN) field of 2 digits. As shown in FIG. 3, a masked IMEISV may have its last 4 digits of the SNR field masked in order to keep from misusing or abusing such information. However, the present disclosure is not limited thereto. In some other embodiments, another identifier than the IMEISV may be used. In some other embodiments, another mask than the last 4 digits of the SNR field may be used.

As described above, MDT measurements are based on UE measurement reports. Basically, in order to configure MDT measurement, the network considers the reported (3GPP defined) UE capability. For NR,
the UE indicates one capability bit for support for Logged MDT in RRC idle and inactive mode, to indicate that the UE supports logging of MDT measurements;
the UE may indicate capability for stand-alone GNSS positioning;
the NR UE may indicate a capability for support of UL Packet Data Convergence Protocol (PDCP) delay measurement.

However, the MDT performance can be different by UE vendor and SW version even though UE supports the above capabilities. For instance, one type of UE always reports the location information while another type of UE from another vendor reports the location information when there is difference between its current and previous locations. As the location information is crucial for MDT from operator's point of view, it is desirable for the network to configure MDT measurement for the UE which can report location continuously.

In addition, MDT functionality is extremely important at the initial cell setup phase, for example when a new frequency or a new radio access technology is deployed. For instance, when NR cells are newly deployed, operators want to know whether the cell is properly deployed and downlink signal level is enough for the UE to connect/communicate with the cell. It is however not possible to limit MDT configurations only to those UEs supporting access to the newly deployed cells. Even if selection of such UEs was possible, the measurement performance can be different depending on UE vendors and/or software versions. This may lead to inconsistent measurements from which it is not possible to deduce, for example, whether the cells have been deployed with the desired coverage.

Further, there can be malfunctioning UE types. With the current specifications for MDT, the MDT measurements collected by such faulty UEs need to be filtered out. The operator is required to pay much effort to exclude the MDT results measured by such UEs after receiving measurement results unless there is a way to rule out such UEs when the MDT measurements are configured.

Additionally, an operator may be interested in using MDT to monitor the performance of a given feature or to check that UEs using a specific service are being served with the expected performance. This would require that only specific UEs are selected for MDT configuration, but this is not possible. Hence the operator would need to perform resource intensive post processing of MDT measurements in order to extrapolate the results that are relevant to the service/feature that wants to be monitored. This may not even be possible if the MDT measurements cannot be associated to UEs with specific characteristics or using specific services.

In some embodiments, it is proposed that the MDT Configuration may contain UE Selection Information that allow the RAN to deduce how to select the UEs to be configured for MDT measurement collection. In some other embodiments, the UE Selection Information may be included in the subscriber information associated to each UE and is passed to the RAN at UE context setup, e.g. as part of the MDT user consent information (e.g. corresponding to the Management Based MDT PLMN List). Namely, the information provided per UE may specify whether, e.g. the UE can be selected for MDT measurement configuration only if it is using a given service, or only if it is served on a specific frequency. In some embodiments, the UE selection information may be provided partially in the MDT configuration and partially in the subscriber information.

In some embodiments, the UE Selection Information signaled to the RAN to allow the RAN to select specific UEs for MDT measurement collection may consist of one or more of the following criteria. It should be noted that, in some embodiments, the information below is additional to the existing information available to the RAN to filter selection of UEs for MDT. For example, the information below is additional to the user consent (e.g. Management Based MDT PLMN List) provided by each UE, which indicates in which PLMN a UE can be selected for MDT measurement configuration.
One or more Masked IMEISVs, enabling the RAN to select, for the MDT measurement configuration, the UEs with the indicated IMEISV. For example, a UE that has an IMEISV having the same digits as those of an indicated masked IMEISV except for the masked digits may be selected. The Masked IMEISV IE may contain the UE vendor information (TAC, leftmost 8 bits of a masked IMEISV) and SW version information (SVN). Therefore, it may improve the NR MDT configuration by supporting UE vendor and SW version.
Indication of one or more UE capabilities. The list of UE capabilities may be derived from the UE capabilities listed in, e.g. TS 38.306 for the case of 5G. Such capabilities together may allow the RAN to select UEs supporting specific features, or characteristics. For example, if the “maxNumberMIMO-LayersPDSCH” capability is indicated with a specific value, this indicates the number of DL Multiple-Input-Multiple-Output (MIMO) layers that UEs to be selected for MDT measurements should support.
Indication of type of service the UE should support when MDT measurements are configured. Such services may be identified in a number of ways, for example using one or more of the following identification information:
   i. By means of a service identifier, e.g. “URLLC service”, “MBB service”;
   ii. By means of the 5QI associated to a QoS Flow, or by means of the QCI associated to a DRB;
   iii. By means of a classification based on whether the service is GBR or non-GBR;
   iv. By means of a classification based on service identifiers resembling the information in the EstablishmentCause IE in TS 38.331, namely identifiers such as “emergency, highPriorityAccess, mt-Access, mo-Signalling, mo-Data, mo-VoiceCall, mo-VideoCall, mo-SMS, mps-PriorityAccess, mcs-PriorityAccess”.
Indication of mobility state the UE shall be in when MDT is configured, e.g. High/Medium/Low (or Normal) Mobility State or indication of mobility state the UE shall be in when MDT measurement is performed.
   i. Alternatively, an indication of UE storing mobility state when the MDT measurement is performed.
Indication of frequency and/or frequency band the UE is using when configuring MDT. As an example, one or more of the following identifiers may be used:
   i. Licensed frequency;
   ii. Unlicensed frequency;
   iii. high/medium/low frequency, e.g., FR1 and/or FR2;
   iv. ARFCN value;
   v. Frequency band index.
Indication of the network slice the UE is using when configuring MDT, e.g. the one or more S-NSSAI of the slice the UE shall be using when MDT is configured at the UE

In some embodiments, the MDT configuration may also include an indication of minimum number of UEs to be selected for the MDT measurement process. Such number of UEs may be defined as per one or more of the following conditions:
Minimum number of UEs per MDT measurement configuration;
Minimum number of UEs per cell;
Minimum number of UEs per Tracking Area;
Minimum number of UEs per PLMN;
Minimum number of UEs per RAN node; and
Minimum number of UEs for each of the information contained in the UE Selection Information.

The methods described in some embodiments of the present disclosure focus on the feature of minimization of drive test and take the 5G system as an example to explain the details of the solutions. However, the person skilled in the art can easily deduce from some embodiments of the present disclosure that the methods described apply to all telecommunication systems where MDT is supported, e.g. 3G and 4G systems.

In some embodiments, the proposed solution may enable the RAN to receive information that allow specific selection of UEs for MDT measurement configuration, where the selected UEs may be selected according to precise criteria. Some embodiments of the present disclosure may also allow the RAN to be informed of the minimum number of UEs that should be selected for the MDT measurements to be configured. Some embodiments of the present disclosure may allow the information according to which specific UE selection is performed to be signaled either as part of the MDT Configuration or as part of UE subscribers' information. Some embodiments of the present disclosure may allow the information according to which specific UE selection is performed to be signaled as both part of the MDT Configuration and part of UE subscribers' information. Some embodiments of the present disclosure may allow the information according to which specific UE selection is performed to be signaled repeatedly as part of the MDT Configuration and as part of UE subscribers' information. In such a case, one of them may override the other.

With some embodiments of the present disclosure, it is possible to tailor an MDT measurement collection process to UEs with specific characteristics, so to enable the operator to monitor specific aspects of the network. When compared with another design choice where UEs are selected in a random way and post processing of UE measurements is performed to try to group the measurement results in statistics targeting specific services or features, the other design choice would delay the availability of measurement results and it would require more resources at post processing. As an example of the advantage of some embodiments of the present disclosure, an operator can activate Management Based MDT to the specific UE vendor and software (SW) version. If specific UE vendor and SW version do not support some function of MDT measurement, the operator can exclude them from the Management Based MDT. In addition, this enables the operator/network vendor to find out the root cause easily (i.e. whether the problem is raised due to network issue or UE vendor issue) when the MDT function does not function as intended so that it is possible to speed up network optimization.

In some embodiments, the RAN may receive UE Selection Information described above that the RAN can use to select specific UEs for the configuration of MDT measurements according to a received MDT Configuration.

In some embodiments, the MDT Configuration may be a Management Based MDT Configuration.

In some embodiments, the RAN may receive together with or separately from the UE Selection Information, information concerning the Minimum Number of UEs as described above. This information may be used by the RAN to select a minimum number of UEs for the MDT configuration.

In some embodiments, if the RAN is not able to select a number of UEs that is at least equal to the minimum number of UEs received, the RAN may perform one or more of the following actions:
Fail the MDT measurement process and not report any indication to the OAM;
Fail the MDT measurement process and notify the OAM with the cause of the failure, i.e. that an insufficient number of UEs was available for the MDT measurement configuration;
Collect measurements from the UEs available, although such UEs do not meet the minimum number required, and report the MDT measurements to the OAM with one or more of these indications:
   i. The number of UEs selected was lower than the indicated minimum;
   ii. An Indication of the exact number of UEs selected;
   iii. A reason why a sufficient number of UEs was not selected, e.g. processing power limitations.

In some embodiments, for determining whether a enough number of UEs are selected, time duration information may be optionally provided to RAN. Then, the RAN node may decide whether the RAN is able to select a number of UEs that is at least equal to the received minimum number of UEs when the indicated time duration has elapsed.

In some embodiments, the UE Selection Information may consist of the Masked IMEISV. A description of such a use case is provided below. However, it is obvious to the person skilled in the art from some embodiments of the present disclosure that the Masked IMEISV may be replaced by one or a plurality of information (e.g., frequency (band) list, mobility state, UE capability, type of service, or the like) included in the UE Selection Information while still achieving a valid example of how the methods described may be implemented.

In some embodiments, the Masked IMEISV information for Management based MDT may indicate:
TAC (Type allocation code) which implies a UE model; and/or
SVN (Software version number).

In some embodiments, the Masked IMEISV information may include one or more above IMEISV entries.

In some embodiments, the RAN node may receive the IMEISV information via at least one of:
an interface management related message from core network (e.g. NG SETUP REQUEST, RAN CONFIGURATION UPDATE, AMF CONFIGURATION UPDATE);
a UE related message from core network: INITIAL CONTEXT SETUP REQUEST or HANDOVER REQUEST message in case of NR;
an MDT activation signal from the Management System. Any downlink message from core network can be candidate for including the IMEISV information.

In some embodiments, the RAN node may select the UE which will perform MDT measurement based on the received IMEISV information as well as PLMN information included in the MDT user consent information and in the MDT area scope. Specifically, if a UE's serving PLMN is included in Management based MDT PLMN List and in the MDT Area Scope and UE's TAC and/or SVN is included in the received Masked IMEISV information, the RAN node can select the UE.

In some embodiments, the Masked IMEISV may be a part of the UE Selection Information. As mentioned, the Masked IMEI SV may be complemented by some or all of the UE selection information described above.

In some embodiments, if multiple information is received as part of the UE Selection Information, the RAN node may select the UE which satisfies all the received criteria.

In some embodiments, the RAN may receive priority levels for each information (or criteria) in the UE Selection Information. The RAN may select UEs based on the UE Selection Information taken in order of priority. For example, if an insufficient number of UEs is available to satisfy all the selection criteria in the UE Selection Information, then the RAN may discard UE selection criteria with lower Priority Levels. If no UEs are available to satisfy all the selection criteria in the UE Selection Information, then the RAN may discard UE selection criteria with lower Priority Levels and check if UEs are available with such reduced list of selection criteria. Even after discarding the lowest priority selection criteria, if no UEs are available to satisfy all the selection criteria in the UE Selection Information, RAN may discard the second lowest criteria. This discarding procedure is performed until the enough number of UEs are selected to satisfy the minimum number of UEs received.

In some embodiments, for determining whether to discard subset of criteria, time duration information may be optionally provided to RAN. Then, the RAN node may decide whether to perform discarding criteria from lowest priority when the indicated time duration has elapsed.

If the RAN discards the part of criteria to select the sufficient number of UEs, the RAN may notify the OAM with the discarded criteria.

In some embodiments, for each specified period of time, the RAN may discard one criteria with the lowest priority at that time. In this way, the RAN may select more UEs to try to satisfy the requirement of the minimum number of UEs, until finally a sufficient number of UEs can be selected for MDT.

In some embodiments, the MDT measurement can be immediate MDT (which is measured during RRC connected state) and logged MDT (which is measured during RRC idle or RRC inactive state).

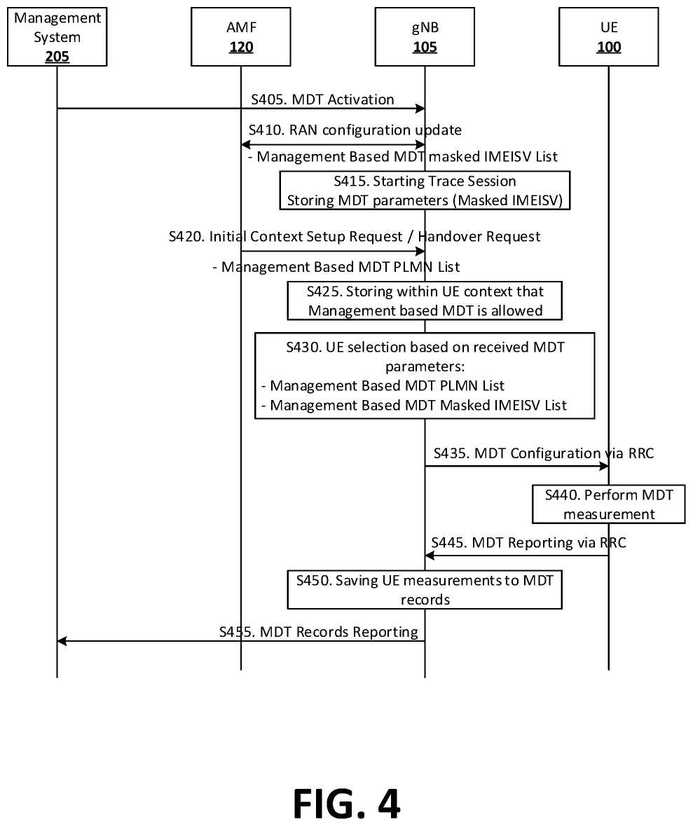

Next, several specific examples will be described with reference to FIG. 4 through FIG. 9. FIG. 4 through FIG. 9 are diagrams illustrating exemplary MDT procedures in which UE selection for MDT is applied according to some embodiments of the present disclosure.

FIG. 4 is a diagram illustrating an exemplary MDT procedure in which the UE selection information comprising masked IMEISV information is provided by the AMF 120 to the gNB 105 via a RAN configuration update message.

At step S405, the Management System 205 may activate MDT, for example, in a similar manner as step S210 shown in FIG. 2.

At step S410, the AMF 120 may send the Management Based MDT Masked IMEISV List to gNB 105 via RAN CONFIGURATION UPDATE. Then, gNB 105 may start the trace session and store the received MDT parameters and/or the UE selection information at step S415.

At step S420, the AMF 120 may send the Management Based MDT PLMN list IE to gNB 105 via Initial Context Setup Request or Handover Request, in a similar manner as step S220. Then, gNB 105 may store the received MDT allowed information at step S425 in a similar manner as step S225.

At step S430, gNB 105 may select UEs based on the received MDT allowed information and/or the UE selection information:
Management Based MDT PLMN List, and/or
Management Based MDT Masked IMEISV List,
as will be described below with reference to FIG. 10.

At step S435, gNB 105 may send an MDT configuration to the selected UE 100. Then, the UE 100 may perform MDT measurement at step S440 and send an MDT measurement report to gNB 105 at step S445.

The gNB 105 may save the UE measurement report to MDT records at step S450 and send the MDT records to the Management System 205 at S455.

With the embodiment shown in FIG. 4, UEs that have the indicated IMEISVs may be selected for MDT measurements and reporting.

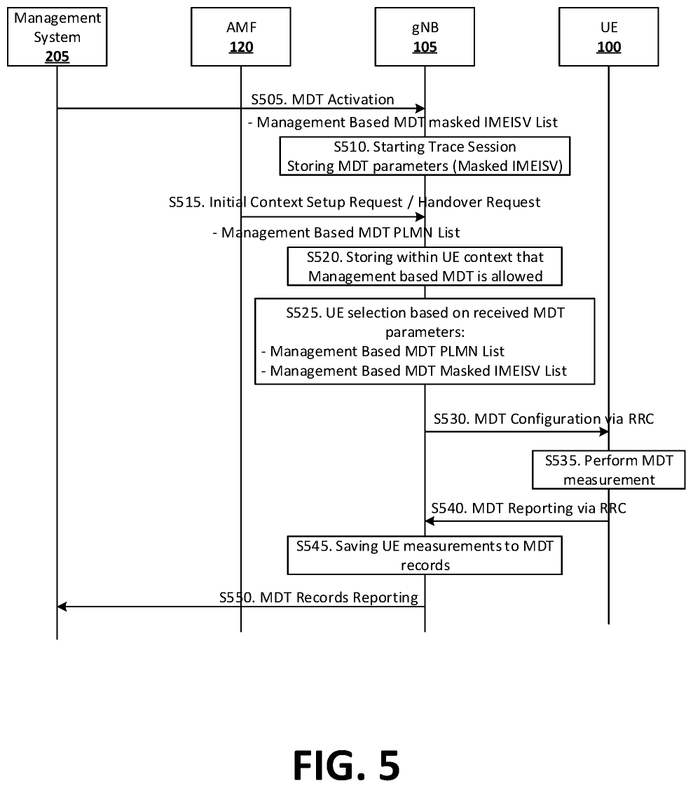

FIG. 5 is a diagram illustrating an exemplary MDT procedure in which the UE selection information comprising masked IMEISV information is provided by the management system 205 to the gNB 105 via an MDT activation message.

At step S505, the Management System 205 may activate MDT, for example, in a similar manner as step S210 shown in FIG. 2. Unlike the embodiment of FIG. 4, the MDT activation message may further comprise Management Based MDT Masked IMEISV List. In other words, the Management Based MDT Masked IMEISV List is not carried by the RAN configuration update message as shown at step S410 in FIG. 4. However, the present disclosure is not limited thereto. In some other embodiments, the Management Based MDT Masked IMEISV List may be transmitted from both of the management system 205 and the AMF 120, and one of them may override the other, for example, depending on a predetermined rule.

At step S515, the AMF 120 may send the Management Based MDT PLMN list IE to gNB 105 via Initial Context Setup Request or Handover Request, in a similar manner as step S220. Then, gNB 105 may start the trace session and store the received MDT allowed information at step S520 in a similar manner as step S225.

At step S525, gNB 105 may select UEs based on the received MDT allowed information and/or the UE selection information:
Management Based MDT PLMN List, and/or
Management Based MDT Masked IMEISV List,
as will be described below with reference to FIG. 10.

At step S530, gNB 105 may send an MDT configuration to the selected UE 100. Then, the UE 100 may perform MDT measurement at step S535 and send an MDT measurement report to gNB 105 at step S540.

The gNB 105 may save the UE measurement report to MDT records at step S545 and send the MDT records to Management System 205 at S550.

With the embodiment shown in FIG. 5, UEs that have the indicated IMEISVs may also be selected for MDT measurements and reporting.

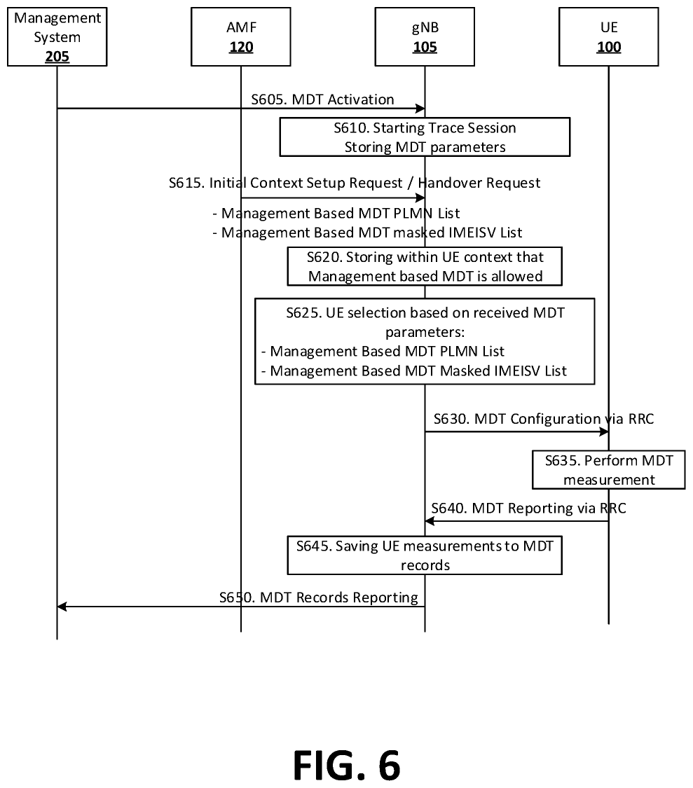

FIG. 6 is a diagram illustrating an exemplary MDT procedure in which the UE selection information comprising masked IMEISV information is provided by the AMF 120 to the gNB 105 via an INITAIL CONTEXT SETUP REQUEST and/or HANDOVER REQUEST message.

At step S605, the Management System 205 may activate MDT, for example, in a similar manner as step S210 shown in FIG. 2.

At step S610, the gNB 105 may start the trace session and store the received MDT parameters in a similar manner as step S215 shown in FIG. 2.

At step S615, the AMF 120 may send the Management Based MDT PLMN list IE and the Management Based Masked IMEISV List to gNB 105 via Initial Context Setup Request or Handover Request. Then, gNB 105 may store the received MDT allowed information and/or the UE selection information at step S620.

At step S625, gNB 105 may select UEs based on the received MDT allowed information and/or the UE selection information:
Management Based MDT PLMN List, and/or
Management Based MDT Masked IMEISV List,
as will be described below with reference to FIG. 10.

At step S630, gNB 105 may send an MDT configuration to the selected UE 100. Then, the UE 100 may perform MDT measurement at step S635 and send an MDT measurement report to gNB 105 at step S640.

The gNB 105 may save the UE measurement report to MDT records at step S645 and send the MDT records to Management System 205 at S650.

In the embodiment shown in FIG. 6, in case the UE 100 moves from one cell to another cell via the handover procedure, Management Based MDT Masked IMEISV List may be transferred from the source cell to the target cell during the handover preparation via e.g. HANDOVER REQUIRED (in case of NG handover) or HANDOVER REQUEST (in case of Xn handover).

With the embodiment shown in FIG. 6, UEs that have the indicated IMEISVs may also be selected for MDT measurements and reporting.

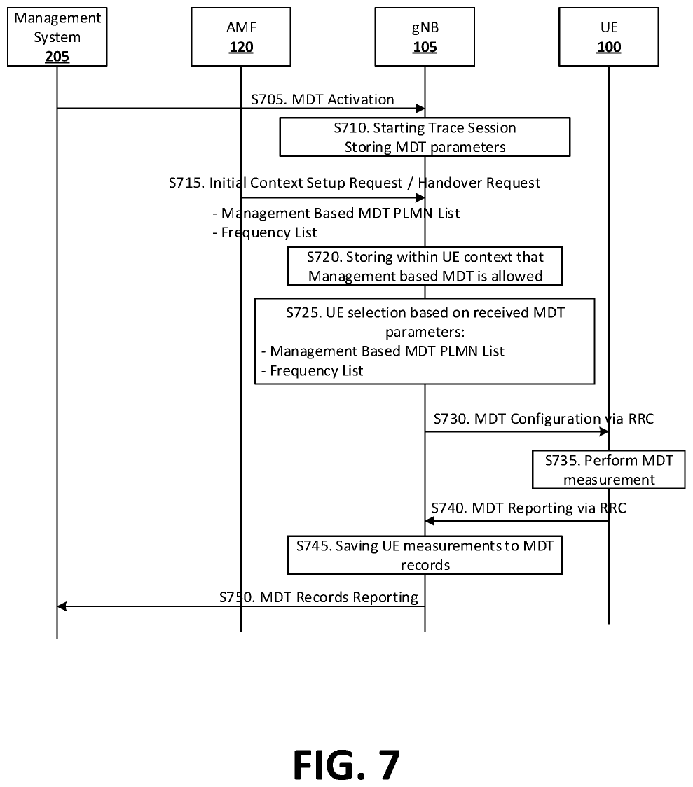

FIG. 7 is a diagram illustrating an exemplary MDT procedure in which the UE selection information comprising Frequency List information is provided by the AMF 120 to the gNB 105 via an INITAIL CONTEXT SETUP REQUEST and/or HANDOVER REQUEST message.

At step S705, the Management System 205 may activate MDT, for example, in a similar manner as step S210 shown in FIG. 2.

At step S710, the gNB 105 may start the trace session and store the received MDT parameters, in a similar manner as step S215 shown in FIG. 2.

At step S715, the AMF 120 may send the Frequency List IE and the Management Based Masked IMEISV List to gNB 105 via Initial Context Setup Request or Handover Request. Then, gNB 105 may store the received MDT allowed information and/or the UE selection information at step S720.

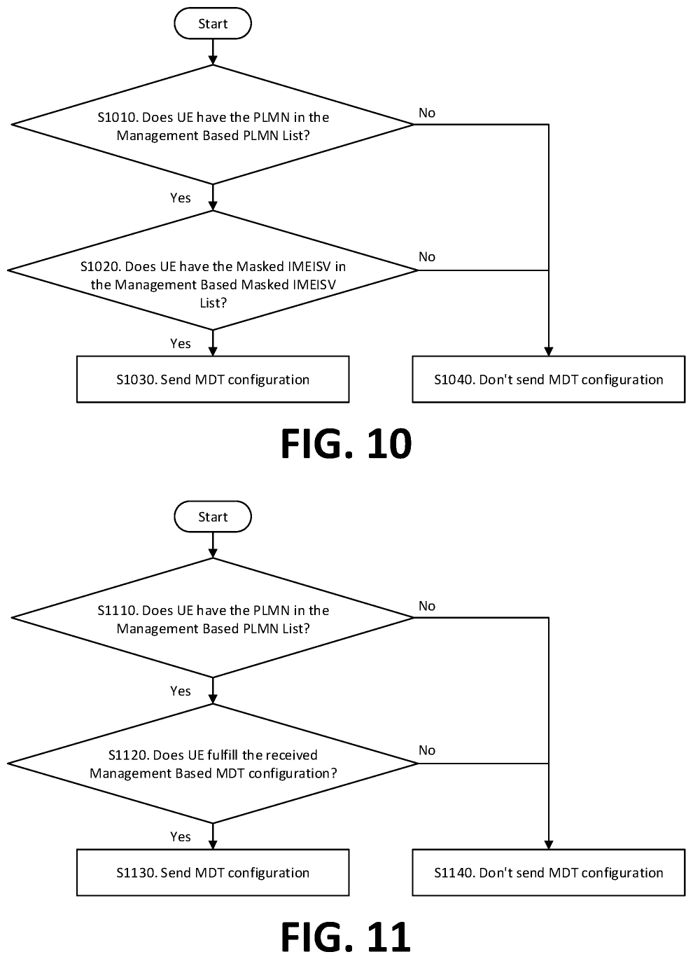

At step S725, gNB 105 may select UEs based on the received MDT allowed information and/or the UE selection information:
Management Based MDT PLMN List, and/or
Frequency List,
as will be described below with reference to FIG. 11.

At step S730, gNB 105 may send an MDT configuration to the selected UE 100. Then, the UE 100 may perform MDT measurement at step S735 and send an MDT measurement report to gNB 105 at step S740.

The gNB 105 may save the UE measurement report to MDT records at step S745 and send the MDT records to Management System 205 at S750.

With the embodiment shown in FIG. 7, UEs that are using the indicated frequencies may be selected for MDT measurements and reporting.

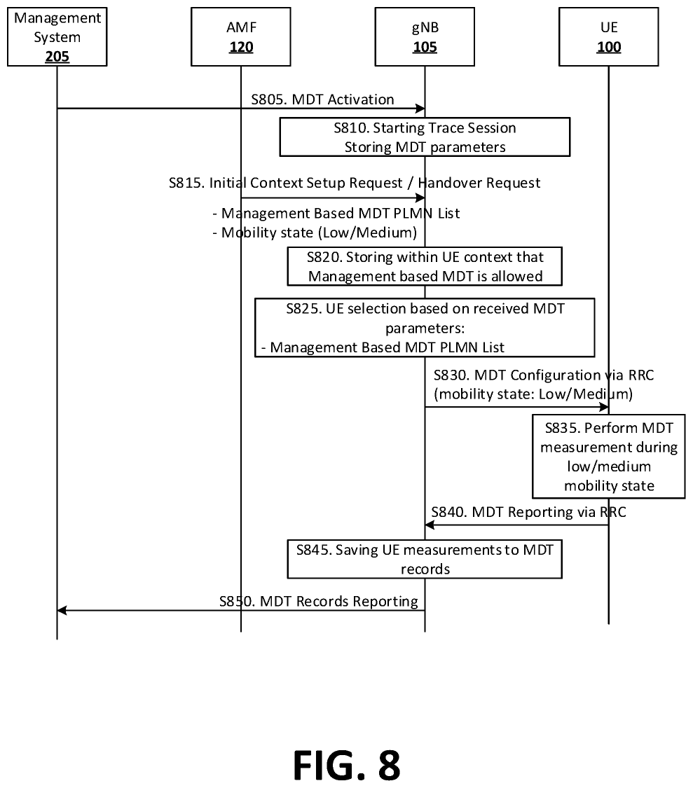

FIG. 8 is a diagram illustrating an exemplary MDT procedure in which the UE selection information comprising Mobility State information is provided by the AMF 120 to the gNB 105 via an INITAIL CONTEXT SETUP REQUEST and/or HANDOVER REQUEST message.

At step S805, the Management System 205 may activate MDT, for example, in a similar manner as step S210 shown in FIG. 2.

At step S810, the gNB 105 may start the trace session and store the received MDT parameters, in a similar manner as step S215 shown in FIG. 2.

At step S815, the AMF 120 may send the Mobility State IE (e.g., indicating a Low or Medium mobility state) and the Management Based MDT PLMN List to gNB 105 via Initial Context Setup Request or Handover Request. Then, gNB 105 may store the received MDT allowed information and/or the UE selection information at step S820.

At step S825, gNB 105 may select UEs based on the received MDT allowed information: Management Based MDT PLMN List. However, the present disclosure is not limited thereto. In some other embodiments, the gNB 105 may select UEs based on the received MDT allowed information and/or the UE selection information: Management Based MDT PLMN List and/or Mobility State. For example, the gNB 105 may select UEs that are currently residing in a PLMN of the indicated PLMN list and having a mobility state of Low or Medium.

At step S830, gNB 105 may send an MDT configuration comprising the received mobility state information (i.e., Low and/or Medium) to the selected UE 100. Then, the UE 100 may perform MDT measurement during staying in the indicated mobility state and do not perform MDT measurement during not staying in the indicated mobility state at step S835, and send an MDT measurement report to gNB 105 at step S840. However, the present disclosure is not limited thereto. In some other embodiments, the selected UEs may still perform MDT measurement even if it is not in the indicated mobility state as long as it was in the indicated mobility state when it was selected.

The gNB 105 may save the UE measurement report to MDT records at step S845 and send the MDT records to the Management System 205 at S850.

With the embodiment shown in FIG. 8, UEs that are having an indicated mobility state may be selected for MDT measurements and reporting.

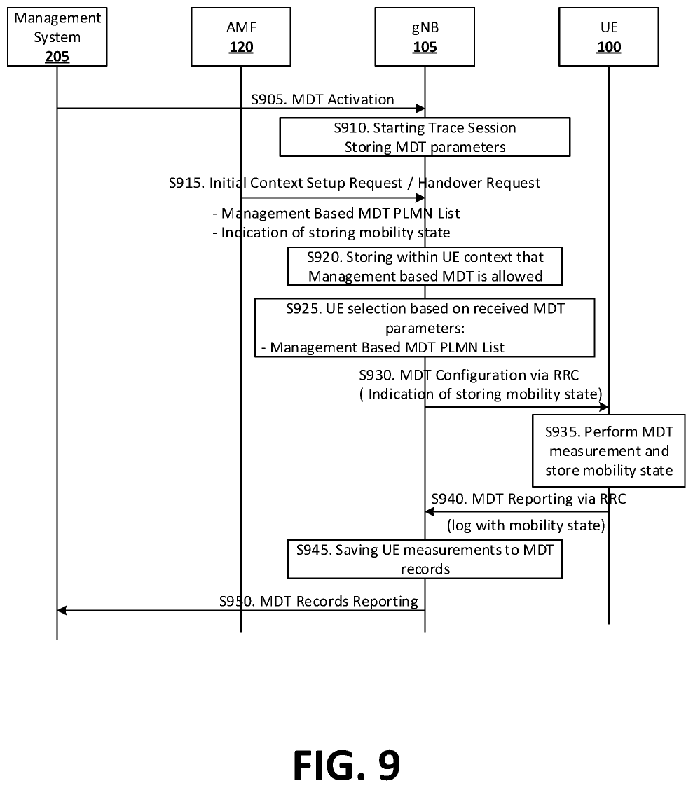

FIG. 9 is a diagram illustrating an exemplary MDT procedure in which the UE selection information comprising an indication of storing Mobility State information is provided by the AMF 120 to the gNB 105 via an INITAIL CONTEXT SETUP REQUEST and/or HANDOVER REQUEST message.

At step S905, the Management System 205 may activate MDT, for example, in a similar manner as step S210 shown in FIG. 2.

At step S910, the gNB 105 may start the trace session and store the received MDT parameters, in a similar manner as step S215 shown in FIG. 2.

At step S915, the AMF 120 may send an indication of storing mobility state information (e.g., Low/Medium/High) and the Management Based MDT PLMN List to gNB 105 via Initial Context Setup Request or Handover Request. Then, gNB 105 may store the received MDT allowed information and/or the UE selection information at step S920.

At step S925, gNB 105 may select UEs based on the received MDT allowed information: Management Based MDT PLMN List. However, the present disclosure is not limited thereto. In some other embodiments, the gNB 105 may select UEs based on the received MDT allowed information and/or the UE selection information: Management Based MDT PLMN List and/or the indication of storing Mobility State information. For example, the gNB 105 may select UEs that are currently residing in a PLMN of the indicated PLMN list and having a mobility state of Low, Medium, or High.

At step S930, gNB 105 may send an MDT configuration comprising the received indication of storing mobility state information (i.e., Low/Medium/High) to the selected UE 100. Then, the UE 100 may store the mobility state information when storing the MDT measured results at step S935, and report the measured results with the stored mobility state information to the gNB 105 at step S940.

The gNB 105 may save the UE measurement report to MDT records at step S945 and send the MDT records to the Management System 205 at S950.

With the embodiment shown in FIG. 9, the selected UEs may report its mobility state together with the MDT measurements.

FIG. 10 is a flow chart illustrating an exemplary method for selecting one or more UEs for MDT according to an embodiment of the present disclosure. In embodiments described above with reference to FIG. 4 through FIG. 6, both Management Based PLMN List and Management Based Masked IMEISV List may be used when gNB 105 selects the UE 100 for MDT configuration.

At steps S1010 and S1020, if the UE 100′s RPLMN belongs to Management Based PLMN List and UE 100′s IMEISV belongs to Masked IMEISV in the Management Based Masked IMEISV List, respectively, that is, both of the “Yes” branches, the RAN node (or gNB 105) may send the MDT configuration to the UE at step S1030. Otherwise, the RAN node (or gNB 105) does not send the MDT configuration to the UE 100 at step S1040.

However, please note that the order of the steps shown in FIG. 10 is not the only way to perform the method shown in FIG. 10. For example, the step S1010 may be swapped with the step S1020.

FIG. 11 is a flow chart illustrating another exemplary method for selecting one or more UEs for MDT according to another embodiment of the present disclosure. The method shown in FIG. 11 is a generalized version of that shown in FIG. 10. That is, in some embodiments, the proposed method is to use both Management Based PLMN List and Management Based MDT configuration (which may comprise at least one of the criteria described above) when gNB 105 selects the UE 100 for MDT configuration. At steps S1110 and S1120, if the UE 100′s RPLMN belongs to Management Based PLMN List and UE 100′s condition satisfies criteria in the management based MDT configuration, respectively, that is, both of the “Yes” branches, the RAN node (or gNB 105) may send the MDT configuration to the UE 100 at step S1130. Otherwise, the RAN node (or gNB 105) does not send the MDT configuration to the UE 100 at step S1140.

However, please note that the order of the steps shown in FIG. 11 is not the only way to perform the method shown in FIG. 11. For example, the step S1110 may be swapped with the step S1120.

With some embodiments described above, it is possible to tailor an MDT measurement collection process to UEs with specific characteristics, so to enable the operator to monitor specific aspects of the network. Further, an operator can activate Management Based MDT to the specific UE vendor and software (SW) version. If specific UE vendor and SW version do not support some function of MDT measurement, the operator can exclude them from the Management Based MDT. In addition, this enables the operator/network vendor to find out the root cause easily (i.e. whether the problem is raised due to network issue or UE vendor issue) when the MDT function does not function as intended so that it is possible to speed up network optimization.

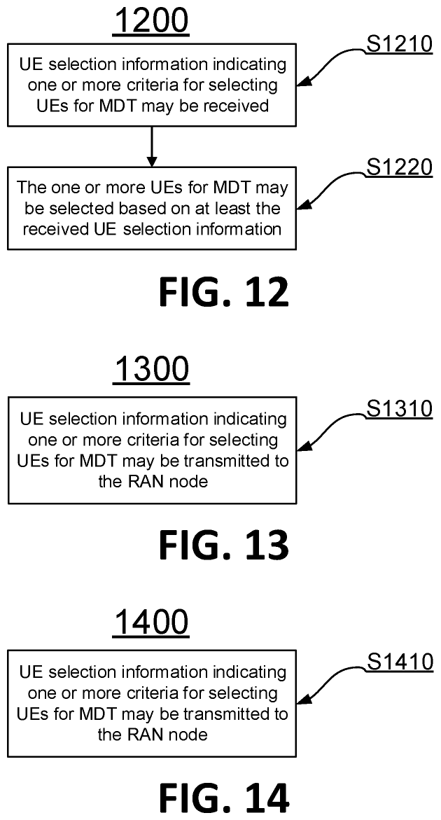

FIG. 12 is a flow chart of an exemplary method 1200 at a RAN node for selecting one or more UEs for MDT according to an embodiment of the present disclosure. The method 1200 may be performed by an RAN node (e.g., the RAN node or gNB 105). The method 1200 may comprise steps S1210 and S1220. However, the present disclosure is not limited thereto. In some other embodiments, the method 1200 may comprise more steps, less steps, different steps, or any combination thereof. Further the steps of the method 1200 may be performed in a different order than that described herein. Further, in some embodiments, a step in the method 1200 may be split into multiple sub-steps and performed by different entities, and/or multiple steps in the method 1200 may be combined into a single step.

The method 1200 may begin at step S1210 where UE selection information indicating one or more criteria for selecting UEs for MDT may be received.

At step S1220, the one or more UEs for MDT may be selected based on at least the received UE selection information.

In some embodiments, the method 1200 may further comprise: receiving user consent information associated with the one or more UEs, wherein the step of selecting the one or more UEs for MDT may be further based on at least the received user consent information. In some embodiments, the user consent information associated with each of the UEs may comprise a list of PLMNs where MDT is allowed for the corresponding UE. In some embodiments, the one or more criteria may indicate at least one of: one or more Masked IMEISVs; one or more UE capabilities; one or more types of service; one or more mobility states; one or more frequencies; one or more frequency bands; and one or more network slices.

In some embodiments, when the criteria indicate the list of PLMNs, each of the one or more UEs selected for MDT may be connected to at least one of the PLMNs in the list. In some embodiments, the one or more masked IMEISVs may comprise at least one masked IMEISV defined in 3GPP TS 38.413, V17.1.1 and/or any of its preceding releases. In some embodiments, when the criteria indicate the one or more masked IMEISVs, each of the one or more UEs selected for MDT may have an IMEISV matched with at least one of the one or more masked IMEISVs. In some embodiments, the one or more UE capabilities may comprise at least one UE capability defined in 3GPP TS 38.306, V17.0.0 and/or any of its preceding releases. In some embodiments, when the criteria indicate the one or more UE capabilities, each of the one or more UEs selected for MDT may support all of the one or more UE capabilities. In some embodiments, the one or more types of service may be classified by at least one of: one or more service identifiers; one or more 5QIs associated to one or more QoS flows; one or more QCIs associated to one or more DRBs; whether a service is a GBR service or a non-GBR service; and one or more establishment causes. In some embodiments, when the criteria indicate the one or more types of service, each of the one or more UEs selected for MDT may support at least one of the one or more types of services.

In some embodiments, the one or more mobility states may comprise at least one mobility state defined in 3GPP TS 38.304, V17.0.0 and/or any of its preceding releases. In some embodiments, when the criteria indicate the one or more mobility states, each of the one or more UEs selected for MDT may have one of the one or more mobility states. In some embodiments, the one or more frequencies and/or one or more frequency bands may be indicated by at least one of: one or more licensed frequencies; one or more unlicensed frequencies; FR1 and/or FR2; one or more ARFCN values; and one or more frequency band indexes. In some embodiments, when the criteria indicate the one or more frequencies and/or frequency bands, each of the one or more UEs selected for MDT may be using at least one of the one or more frequencies and/or at least one of the one or more frequency bands. In some embodiments, when the criteria indicate the one or more network slices, each of the one or more UEs selected for MDT may be using at least one of the one or more network slices.

In some embodiments, when the UE selection information indicates multiple criteria for selecting UEs, the selected UEs may satisfy all of the multiple criteria. In some embodiments, the UE selection information may be received from a management system and/or a CN node. In some embodiments, the UE selection information may be received in at least one of: an MDT configuration from a management system; an interface management related message from a CN node; a UE related message from a CN node. In some embodiments, the interface management related message may comprise at least one of: an NG SETUP REQUEST message; an RAN CONFIGURATION UPDATE message; and an AMF CONFIGURATION UPDATE message. In some embodiments, the UE related message may comprise at least one of: an INITIAL CONTEXT SETUP REQUEST message; and a HANDOVER REQUEST message.

In some embodiments, the method 1200 may further comprise: receiving one or more indicators together with or separately from the UE selection information, each of which indicating a minimum number of UEs that should be selected for MDT under a corresponding condition. In some embodiments, the one or more indicators may indicate at least one of: a minimum number of UEs that should be selected per MDT measurement configuration; a minimum number of UEs that should be selected per cell; a minimum number of UEs that should be selected per TA; a minimum number of UEs that should be selected per PLMN; and a minimum number of UEs that should be selected per RAN node.

In some embodiments, the method 1200 may further comprise, in response to an indicated minimum number of UEs that should be selected for MDT under a condition being greater than a number of UEs available for selection under the condition, at least one of: failing a MDT measurement process and not reporting any indication; failing a MDT measurement process and reporting a failure cause indicating that there is no sufficient number of UEs available for selection; and collecting and reporting measurements from the selected UEs with an indication indicating at least one of: the number of the selected UEs being less than the indicated minimum number; the number of the selected UEs; and a reason why the indicated minimum number of UEs are not selected.

In some embodiments, when the UE selection information indicates multiple criteria for selecting UEs, each of the multiple criteria may have an associated priority level. In some embodiments, when there is no sufficient number of UEs that satisfy all of the multiple criteria and are available for selection for a specified period of time, the multiple criteria may be discarded one by one in an ascending order of their priority levels after every specified period of time until a sufficient number of UEs that satisfy the remaining criteria are available for selection. In some embodiments, the method 1200 may further comprise: reporting the criteria that are discarded. In some embodiments, the MDT may be a Management Based MDT. In some embodiments, the MDT may be an immediate MDT and/or a logged MDT.

FIG. 13 is a flow chart of an exemplary method 1300 at a management system for facilitating a RAN node in selecting one or more UEs for MDT according to an embodiment of the present disclosure. The method 1300 may be performed by a management system (e.g., the management system 205). The method 1300 may comprise a step S1310. However, the present disclosure is not limited thereto. In some other embodiments, the method 1300 may comprise more steps, different steps, or any combination thereof. Further the steps of the method 1300 may be performed in a different order than that described herein. Further, in some embodiments, a step in the method 1300 may be split into multiple sub-steps and performed by different entities, and/or multiple steps in the method 1300 may be combined into a single step.

The method 1300 may begin at step S1310 where UE selection information indicating one or more criteria for selecting UEs for MDT may be transmitted to the RAN node.

In some embodiments, the criteria may indicate at least one of: one or more Masked IMEISVs; one or more UE capabilities; one or more types of service; one or more mobility states; one or more frequencies; one or more frequency bands; and one or more network slices. In some embodiments, the one or more masked IMEISVs may comprise at least one masked IMEISV defined in 3GPP TS 38.413, V17.1.1 and/or any of its preceding releases. In some embodiments, the one or more UE capabilities may comprise at least one UE capability defined in 3GPP TS 38.306, V17.0.0 and/or any of its preceding releases. In some embodiments, the one or more types of service may be classified by at least one of: one or more service identifiers; one or more 5QIs associated to one or more QoS flows; one or more QCIs associated to one or more DRBs; whether a service is a GBR service or a non-GBR service; and one or more establishment causes. In some embodiments, the one or more mobility states may comprise at least one mobility state defined in 3GPP TS 38.304, V17.0.0 and/or any of its preceding releases. In some embodiments, the one or more frequencies and/or one or more frequency bands may be indicated by at least one of: one or more licensed frequencies; one or more unlicensed frequencies; FR1 and/or FR2; one or more ARFCN values; and one or more frequency band indexes.

In some embodiments, the UE selection information may be transmitted in an MDT configuration from the management system to the RAN node. In some embodiments, the method 1300 may further comprise: transmitting, to the RAN node, one or more indicators together with or separately from the UE selection information, each of which indicating a minimum number of UEs that should be selected for MDT under a corresponding condition. In some embodiments, the one or more indicators may indicate at least one of: a minimum number of UEs that should be selected per MDT measurement configuration; a minimum number of UEs that should be selected per cell; a minimum number of UEs that should be selected per TA; a minimum number of UEs that should be selected per PLMN; and a minimum number of UEs that should be selected per RAN node.

In some embodiments, the method 1300 may further comprise at least one of: receiving, from the RAN node, a failure cause indicating that there is no sufficient number of UEs available for selection; and receiving, from the RAN node, measurements from the selected UEs with an indication indicating at least one of: the number of the selected UEs being less than the indicated minimum number; the number of the selected UEs; and a reason why the indicated minimum number of UEs are not selected.

In some embodiments, when the UE selection information indicates multiple criteria for selecting UEs, each of the multiple criteria may have an associated priority level. In some embodiments, the method 1300 may further comprise: receiving, from the RAN node, a message indicating the criteria that are discarded by the RAN node. In some embodiments, the MDT may be a Management Based MDT. In some embodiments, the MDT may be an immediate MDT and/or a logged MDT.

FIG. 14 is a flow chart of an exemplary method 1400 at a CN node for facilitating a RAN node in selecting one or more UEs for MDT according to an embodiment of the present disclosure. The method 1400 may be performed by a CN node (e.g., the AMF 120). The method 1400 may comprise a step S1410. However, the present disclosure is not limited thereto. In some other embodiments, the method 1400 may comprise more steps, different steps, or any combination thereof. Further the steps of the method 1400 may be performed in a different order than that described herein. Further, in some embodiments, a step in the method 1400 may be split into multiple sub-steps and performed by different entities, and/or multiple steps in the method 1400 may be combined into a single step.

The method 1400 may begin at step S1410 where UE selection information indicating one or more criteria for selecting UEs for MDT may be transmitted to the RAN node.

In some embodiments, the method 1400 may further comprise: transmitting, to the RAN node, user consent information associated to one or more UEs. In some embodiments, the user consent information associated with each of the UEs may comprise a list of PLMNs where MDT is allowed for the corresponding UE. In some embodiments, the criteria may indicate at least one of: one or more Masked IMEISVs; one or more UE capabilities; one or more types of service; one or more mobility states; one or more frequencies; one or more frequency bands; and one or more network slices. In some embodiments, the one or more masked IMEISVs may comprise at least one masked IMEISV defined in 3GPP TS 38.413, V17.1.1 and/or any of its preceding releases. In some embodiments, the one or more UE capabilities may comprise at least one UE capability defined in 3GPP TS 38.306, V17.0.0 and/or any of its preceding releases. In some embodiments, the one or more types of service may be classified by at least one of: one or more service identifiers; one or more 5QIs associated to one or more QoS flows; one or more QCIs associated to one or more DRBs; whether a service is a GBR service or a non-GBR service; and one or more establishment causes. In some embodiments, the one or more mobility states may comprise at least one mobility state defined in 3GPP TS 38.304, V17.0.0 and/or any of its preceding releases. In some embodiments, the one or more frequencies and/or one or more frequency bands may be indicated by at least one of: one or more licensed frequencies; one or more unlicensed frequencies; FR1 and/or FR2; one or more ARFCN values; and one or more frequency band indexes.

In some embodiments, the UE selection information may be transmitted in at least one of: an interface management related message; a UE related message. In some embodiments, the interface management related message comprises at least one of: an NG SETUP REQUEST message; an RAN CONFIGURATION UPDATE message; and an AMF CONFIGURATION UPDATE message. In some embodiments, the UE related message comprises at least one of: an INITIAL CONTEXT SETUP REQUEST message; and a HANDOVER REQUEST message.

In some embodiments, the method 1400 may further comprise: transmitting, to the RAN node, one or more indicators together with or separately from the UE selection information, each of which indicating a minimum number of UEs that should be selected for MDT under a corresponding condition. In some embodiments, the one or more indicators may indicate at least one of: a minimum number of UEs that should be selected per MDT measurement configuration; a minimum number of UEs that should be selected per cell; a minimum number of UEs that should be selected per TA; a minimum number of UEs that should be selected per PLMN; and a minimum number of UEs that should be selected per RAN node. In some embodiments, when the UE selection information indicates multiple criteria for selecting UEs, each of the multiple criteria may have an associated priority level. In some embodiments, the MDT may be a Management Based MDT. In some embodiments, the MDT may be an immediate MDT and/or a logged MDT.

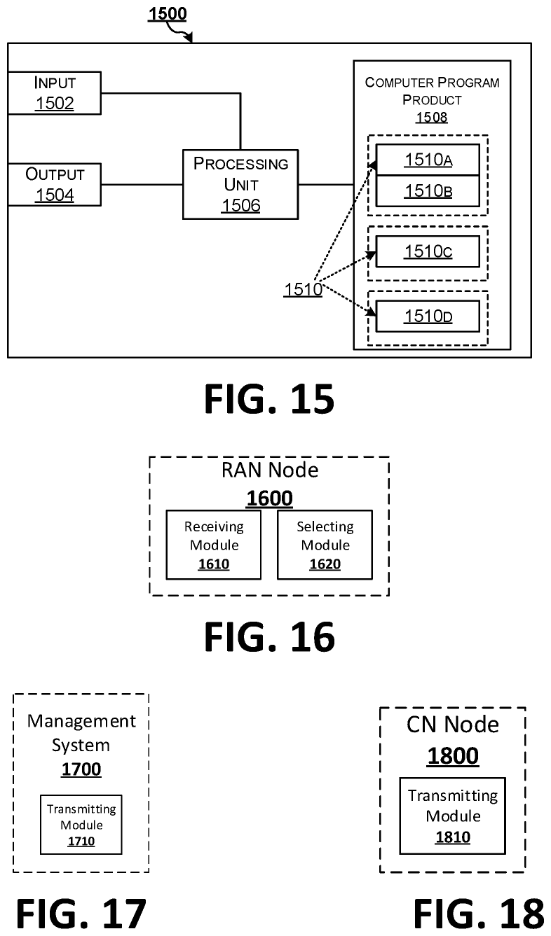

FIG. 15 schematically shows an embodiment of an arrangement which may be used in a RAN node, a management system and/or a CN node according to an embodiment of the present disclosure. Comprised in the arrangement 1500 are a processing unit 1506, e.g., with a Digital Signal Processor (DSP) or a Central Processing Unit (CPU). The processing unit 1506 may be a single unit or a plurality of units to perform different actions of procedures described herein. The arrangement 1500 may also comprise an input unit 1502 for receiving signals from other entities, and an output unit 1504 for providing signal(s) to other entities. The input unit 1502 and the output unit 1504 may be arranged as an integrated entity or as separate entities.

Furthermore, the arrangement 1500 may comprise at least one computer program product 1508 in the form of a non-volatile or volatile memory, e.g., an Electrically Erasable Programmable Read-Only Memory (EEPROM), a flash memory and/or a hard drive. The computer program product 1508 comprises a computer program 1510, which comprises code/computer readable instructions, which when executed by the processing unit 1506 in the arrangement 1500 causes the arrangement 1500 and/or the network node(s) in which it is comprised to perform the actions, e.g., of the procedure described earlier in conjunction with FIG. 4 through FIG. 14 or any other variant.

The computer program 1510 may be configured as a computer program code structured in computer program modules 1510A and 1510B. Hence, in an exemplifying embodiment when the arrangement 1500 is used in a RAN node for selecting one or more UEs for MDT, the code in the computer program of the arrangement 1500 includes: a module 1510A configured to receive UE selection information indicating one or more criteria for selecting UEs for MDT; and a module 1510B configured to select the one or more UEs for MDT based on at least the received UE selection information. In some embodiments, the RAN node may comprise one or more further modules configured to configured to perform one or more steps of any of the methods described with reference to FIG. 12.

Additionally or alternatively, the computer program 1510 may be configured as a computer program code structured in a computer program module 1510C. Hence, in an exemplifying embodiment when the arrangement 1500 is used in a management system for facilitating a RAN node in selecting one or more UEs for MDT, the code in the computer program of the arrangement 1500 includes: a module 1510C configured to transmit, to the RAN node, UE selection information indicating one or more criteria for selecting UEs for MDT. In some embodiments, the management system may comprise one or more further modules configured to configured to perform one or more steps of any of the methods described with reference to FIG. 13.

Additionally or alternatively, the computer program 1510 may be configured as a computer program code structured in a computer program module 1510D. Hence, in an exemplifying embodiment when the arrangement 1500 is used in a CN node for facilitating a RAN node in selecting one or more UEs for MDT, the code in the computer program of the arrangement 1500 includes: a module 1510D configured to transmit, to the RAN node, UE selection information indicating one or more criteria for selecting UEs for MDT. In some embodiments, the CN node may comprise one or more further modules configured to configured to perform one or more steps of any of the methods described with reference to FIG. 14.

The computer program modules could essentially perform the actions of the flow illustrated in FIG. 4 through FIG. 14, to emulate the RAN node, the management system, and/or the CN node. In other words, when the different computer program modules are executed in the processing unit 1506, they may correspond to different modules in the network node(s).

Although the code means in the embodiments disclosed above in conjunction with FIG. 15 are implemented as computer program modules which when executed in the processing unit causes the arrangement to perform the actions described above in conjunction with the figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within the RAN node, the management system, and/or the CN node.

Correspondingly to the method 1200 as described above, an exemplary RAN node for selecting one or more UEs for MDT is provided. FIG. 16 is a block diagram of a RAN node 1600 according to an embodiment of the present disclosure. The RAN node 1600 may be, e.g., the RAN node or gNB 105 in some embodiments.

The RAN node 1600 may be configured to perform the method 1200 as described above in connection with FIG. 12. As shown in FIG. 16, the RAN node 1600 may comprise a receiving module 1610 configured to receive UE selection information indicating one or more criteria for selecting UEs for MDT; and a selecting module 1620 configured to select the one or more UEs for MDT based on at least the received UE selection information.

The above modules 1610 and 1620 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 12. Further, the RAN node 1600 may comprise one or more further modules, each of which may perform any of the steps of the method 1200 described with reference to FIG. 12.

Correspondingly to the method 1300 as described above, an exemplary management system for facilitating a RAN node in selecting one or more UEs for MDT is provided. FIG. 17 is a block diagram of a management system 1700 according to an embodiment of the present disclosure. The management system 1700 may be, e.g., the management system 205 in some embodiments.

The management system 1700 may be configured to perform the method 1300 as described above in connection with FIG. 13. As shown in FIG. 17, the management system 1700 may comprise a transmitting module 1710 configured to transmit, to the RAN node, UE selection information indicating one or more criteria for selecting UEs for MDT.

The above module 1710 may be implemented as a pure hardware solution or as a combination of software and hardware, e.g., by one or more of: a processor or a micro-processor and adequate software and memory for storing of the software, a PLD or other electronic component(s) or processing circuitry configured to perform the actions described above, and illustrated, e.g., in FIG. 13. Further, the management system 1700 may comprise one or more further modules, each of which may perform any of the steps of the method 1300 described with reference to FIG. 13.

Correspondingly to the method 1400 as described above, an exemplary CN node for facilitating a RAN node in selecting one or more UEs for MDT is provided. FIG. 18 is a block diagram of a CN node 1800 according to an embodiment of the present disclosure. The CN node 1800 may be, e.g., the AMF 120 in some embodiments.

The CN node 1800 may be configured to perform the method 1400 as described above in connection with FIG. 14. As shown in FIG. 18, the CN node 1800 may comprise a transmitting module 1810 configured to transmit, to the RAN node, UE selection information indicating one or more criteria for selecting UEs for MDT.

The above module 1810 may be implemented as a pure hardware solution or as a combination of software and hardware, e.g., by one or more of: a processor or a micro-processor and adequate software and memory for storing of the software, a PLD or other electronic component(s) or processing circuitry configured to perform the actions described above, and illustrated, e.g., in FIG. 14. Further, the CN node 1800 may comprise one or more further modules, each of which may perform any of the steps of the method 1400 described with reference to FIG. 14.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

1-67. (canceled)

68. A method at a Radio Access Network (RAN) node for selecting one or more User Equipments (UEs) for Minimization of Drive Test (MDT), the method comprising:
receiving UE selection information indicating one or more criteria for selecting UEs for MDT; and
selecting the one or more UEs for MDT based on at least the received UE selection information.

69. The method of claim 68, further comprising:
receiving user consent information associated with the one or more UEs,
wherein the step of selecting the one or more UEs for MDT is further based on at least the received user consent information.

70. The method of claim 69, wherein the user consent information associated with each of the UEs comprises a list of Public Land Mobile Networks (PLMNs) where MDT is allowed for the corresponding UE.

71. The method of claim 68, wherein the one or more criteria indicate at least one of:
one or more Masked International Mobile Equipment Identifier and Software Versions (IMEISVs);
one or more UE capabilities;
one or more types of service;
one or more mobility states;
one or more frequencies;
one or more frequency bands; and
one or more network slices.

72. The method of claim 71, wherein at least one of the following applies:
when the criteria indicate the list of PLMNs, each of the one or more UEs selected for MDT is connected to at least one of the PLMNs in the list;
the one or more masked IMEISVs comprise at least one masked IMEISV defined in Third Generation Partnership Project (3GPP) Technical Specification (TS) 38.413, V17.1.1 and/or any of its preceding releases;
when the criteria indicate the one or more masked IMEISVs, each of the one or more UEs selected for MDT has an IMEISV matched with at least one of the one or more masked IMEISVs;
the one or more UE capabilities comprise at least one UE capability defined in 3GPP TS 38.306, V17.0.0 and/or any of its preceding releases;
when the criteria indicate the one or more UE capabilities, each of the one or more UEs selected for MDT supports all of the one or more UE capabilities;
the one or more types of service are classified by at least one of: one or more service identifiers, one or more 5G Quality of Service (QoS) Identifiers (5QIs) associated to one or more QoS flows, one or more QoS Class Identifiers (QCIs) associated to one or more Data Radio Bearers (DRBs), whether a service is a Guaranteed Bit Rate (GBR) service or a non-GBR service, and one or more establishment causes;
when the criteria indicate the one or more types of service, each of the one or more UEs selected for MDT supports at least one of the one or more types of services;
the one or more mobility states comprise at least one mobility state defined in 3GPP TS 38.304, V17.0.0 and/or any of its preceding releases;
when the criteria indicate the one or more mobility states, each of the one or more UEs selected for MDT has one of the one or more mobility states;
the one or more frequencies and/or one or more frequency bands are indicated by at least one of: one or more licensed frequencies, one or more unlicensed frequencies, Frequency Range 1 (FR1) and/or Frequency Range 2 (FR2), one or more Absolute Radio Frequency Channel Number (ARFCN) values, and one or more frequency band indexes;
when the criteria indicate the one or more frequencies and/or frequency bands, each of the one or more UEs selected for MDT is using at least one of the one or more frequencies and/or at least one of the one or more frequency bands; and
when the criteria indicate the one or more network slices, each of the one or more UEs selected for MDT is using at least one of the one or more network slices.

73. The method of claim 68, further comprising:
receiving one or more indicators together with or separately from the UE selection information, each of which indicates a minimum number of UEs that should be selected for MDT under a corresponding condition.

74. The method of claim 73, wherein the one or more indicators indicate at least one of:
a minimum number of UEs that should be selected per MDT measurement configuration;
a minimum number of UEs that should be selected per cell;
a minimum number of UEs that should be selected per Tracking Area (TA);
a minimum number of UEs that should be selected per PLMN; and
a minimum number of UEs that should be selected per RAN node.

75. A method at a management system for facilitating a RAN node in selecting one or more UEs for MDT, the method comprising:
transmitting, to the RAN node, UE selection information indicating one or more criteria for selecting UEs for MDT.

76. The method of claim 75, wherein the criteria indicate at least one of:
one or more Masked IMEISVs;
one or more UE capabilities;
one or more types of service;
one or more mobility states;
one or more frequencies;
one or more frequency bands; and
one or more network slices.

77. The method of claim 76, wherein at least one of the following applies:
the one or more masked IMEISVs comprise at least one masked IMEISV defined in 3GPP TS 38.413, V17.1.1 and/or any of its preceding releases;
the one or more UE capabilities comprise at least one UE capability defined in 3GPP TS 38.306, V17.0.0 and/or any of its preceding releases;
the one or more types of service are classified by at least one of: one or more service identifiers, one or more 5QIs associated to one or more QoS flows, one or more QCIs associated to one or more DRBs, whether a service is a GBR service or a non-GBR service, and one or more establishment causes;
the one or more mobility states comprise at least one mobility state defined in 3GPP TS 38.304, V17.0.0 and/or any of its preceding releases;
the one or more frequencies and/or one or more frequency bands are indicated by at least one of: one or more licensed frequencies, one or more unlicensed frequencies, FR1 and/or FR2, one or more ARFCN values, and one or more frequency band indexes; and
the UE selection information is transmitted in an MDT configuration from the management system to the RAN node;

78. The method of claim 75, further comprising:
transmitting, to the RAN node, one or more indicators together with or separately from the UE selection information, each of which indicating a minimum number of UEs that should be selected for MDT under a corresponding condition.

79. The method of claim 78, wherein the one or more indicators indicate at least one of:
a minimum number of UEs that should be selected per MDT measurement configuration;
a minimum number of UEs that should be selected per cell;
a minimum number of UEs that should be selected per TA;
a minimum number of UEs that should be selected per PLMN; and
a minimum number of UEs that should be selected per RAN node.

80. A method at a CN node for facilitating a RAN node in selecting one or more UEs for MDT, the method comprising:
transmitting, to the RAN node, UE selection information indicating one or more criteria for selecting UEs for MDT.

81. The method of claim 80, further comprising:
transmitting, to the RAN node, user consent information associated to one or more UEs.

82. The method of claim 81, wherein the user consent information associated with each of the UEs comprises a list of PLMNs where MDT is allowed for the corresponding UE.

83. The method of claim 80, wherein the criteria indicate at least one of:
one or more Masked IMEISVs;
one or more UE capabilities;
one or more types of service;
one or more mobility states;
one or more frequencies;
one or more frequency bands; and
one or more network slices.

84. The method of claim 83, wherein at least one of the following applies:
the one or more masked IMEISVs comprise at least one masked IMEISV defined in 3GPP TS 38.413, V17.1.1 and/or any of its preceding releases;
the one or more UE capabilities comprise at least one UE capability defined in 3GPP TS 38.306, V17.0.0 and/or any of its preceding releases;
the one or more types of service are classified by at least one of: one or more service identifiers, one or more 5QIs associated to one or more QoS flows, one or more QCIs associated to one or more DRBs, whether a service is a GBR service or a non-GBR service, and one or more establishment causes;
the one or more mobility states comprise at least one mobility state defined in 3GPP TS 38.304, V17.0.0 and/or any of its preceding releases;
the one or more frequencies and/or one or more frequency bands are indicated by at least one of: one or more licensed frequencies, one or more unlicensed frequencies, FR1 and/or FR2, one or more ARFCN values, and one or more frequency band indexes; and
the UE selection information is transmitted in at least one of an interface management related message and a UE related message.

85. The method of claim 80, further comprising:
transmitting, to the RAN node, one or more indicators together with or separately from the UE selection information, each of which indicating a minimum number of UEs that should be selected for MDT under a corresponding condition.

86. The method of claim 85, wherein the one or more indicators indicate at least one of:
a minimum number of UEs that should be selected per MIDT measurement configuration;
a minimum number of UEs that should be selected per cell;
a minimum number of UEs that should be selected per TA;
a minimum number of UEs that should be selected per PLMN; and
a minimum number of UEs that should be selected per RAN node.

87. The method of claim 80, wherein when the UE selection information indicates multiple criteria for selecting UEs, each of the multiple criteria has an associated priority level.
